(19) United States
(12) Patent Application Publication
(10) Pub. No.: US 2004/0100183 A1
(43) Pub. Date: May 27, 2004

(54) Illuminable unit

(75) Inventors: Rongxin Pan, Shanghai (CN); Bingri Xian, Shanghai (CN); Shiquan Han, Shanghai (CN)

Correspondence Address: Raymond Y. Chan, Suite 128, 108 N. Ynez Ave., Monterey Park, CA, 91754, US

(73) Assignees: Shanghai Xiang Shan Industry Limited Liability Company; Shanghai Lv Xiang Illumine Co. Ltd., Shanghai (CN)

(21) Appl. No.: 10/718,135

(22) Filed: Nov. 19, 2003

(30) Foreign Application Priority Data
Nov. 19, 2002 (CN) 02261690.X

(51) Int. Cl. H01J 1/62

(52) U.S. Cl. 313/490

(57) ABSTRACT

An illuminable unit includes a light tube having a spiral-shaped light body containing a mercury source therein and two end portions downwardly extended from the light body, a cathode terminal supported at the end portion of said light tube. A conductor enclosure, which has a length approximately equal to a length of the end portion of the light tube, has an upper head portion sealedly mounted within the respective end portion of the light tube in a concealed manner so as to substantially reduce an overall height of the illuminable unit. A conductor wire is electrically extended from the cathode terminal through the conductor enclosure to an exterior of the light tube for electrifying said mercury source while electrical connection.

### BACKGROUND OF THE PRESENT INVENTION

1. Field of Invention

The present invention relates to an illuminable unit, and particularly to an improvement of a spiral-shaped fluorescent lamp.

2. Description of Related Arts

Conventionally, a fluorescent lamp is composed of a light tube with phosphor coating on its inner surface that contains mercury vapor therein. When the fluorescent lamp is electrically excited, the mercury vapor emits ultraviolet rays shooting the phosphor coating to generate visible illumination. Under electric charge, the light tube needs to be in a certain length to achieve a predetermined brightness. Elongated, U-shaped, double-U-shaped and triple-U-shape light tubes are among the most popular shapes for the fluorescent lamp. One objective of designing the lamp is to make it energy-saving and compact. A lamp that is made in spiral or double-spiral shape exemplifies the designs purposefully to achieve the objective. However, the spiral lamp has two end portions extending downwardly, thereby occupying space and rendering the lamp less compact and inconvenient in use. One of the solutions proposed to cope with the shortcoming may be found in Chinese Patent No. ZL02215188.5, entitled “dual amalgam, double spiral fluorescent lamp,” wherein the disclosed lamp includes a lamp tube, from which conductors are laid out to electrically connect with a lamp base, without any end portions extended therefrom. While the disclosed lamp is compact in shape, it unavoidable complicates the manufacturing process, and increases the costs.

### SUMMARY OF THE PRESENT INVENTION

A main object of the present invention is to provide an illuminable unit that includes a spiral light tube having two end portions and a conductor enclosure having a head portion concealed within the respective end portion of the light tube so as to substantially reduce an overall height of the illuminable unit.

Another object of the present invention is to provide an illuminating, unit wherein a conductor wire is abuttingly extended through the conductor enclose within the end portion of the light tube so as to achieve a compact size for the illuminable unit.

The present invention discloses an illuminable unit for generating visible illumination comprising: a cathode; a spiral-shaped light tube internally spread with a layer of phosphor coating and containing mercury source therein, the light tube having two end portions, in which the cathode terminal is disposed; a conductor enclosure with a length substantially equal to that of the end portion is formed abuttingly on the end portion and seals the same such that the end portions are formed without substantial extension in presence of the conductor enclosure; and a conductor wire sealingly enters the conductor enclosure to connect with the cathode terminal, wherein the conductor wire is parallelly arranged along a longitudinal direction of the light tube for achieving a compact arrangement, whereby the mercury substance is adapted for being excited by electric power introduced via the conductor and the cathode to cause the phosphor coating generating visible illumination.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of an illuminable unit according to a preferred embodiment of the present invention.

FIG. 2 is a partially enlarged view illustrating a conductor, conductor enclosure and cathode of the illuminable unit according to the above preferred embodiment of the present invention.

### DETAILED DESCRIPTION OF THE PREFERRED EMBODIMENT

A preferred embodiment of the present invention is better explained in the following paragraphs in reference with the drawings.

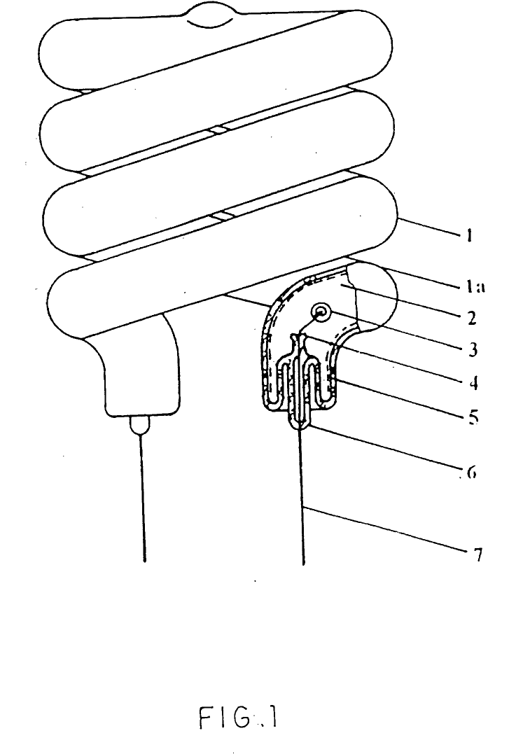

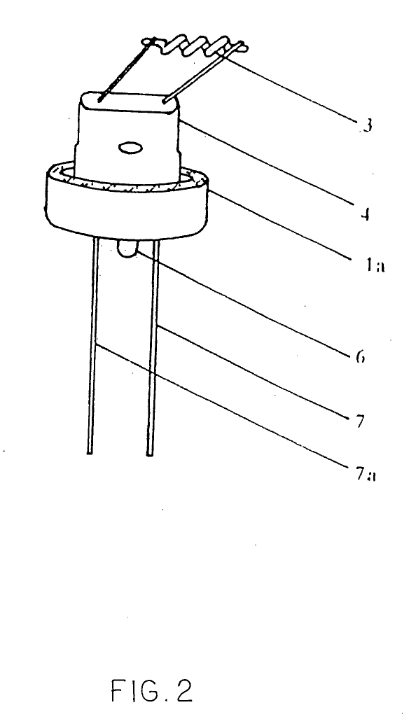

Referring to FIGS. 1 and 2, an illuminable unit of the present invention comprises a double-spiral light tube having a spiral-shaped light body 1, 1a and two end portions downwardly extended therefrom, and a cathode terminal 3 supported at one of the end portions of the light tube.

The light tube further has a light cavity 2 containing a mercury source therein and filling with inert gas, and a phosphor layer 5 coated on an inner wall of the light tube. Accordingly, the two end potions of the light tube are downwardly and parallelly extended from the light body in a vertical extending manner

A conductor enclosure 4, which has a length approximately equal to a length of the end portion of the light tube, has an upper head portion sealedly mounted within the respective end portion of the light tube in a concealed manner so as to substantially reduce an overall height of said illuminable unit. Accordingly, the conductor enclosure 4 is sealed at a bottom end of the end portion of the light tube to conceal the head portion of the conductor enclosure 4 within the end portion of the light tube so as to seal the light cavity in an air tight manner. The conductor enclosure 4 further has an inner gas exhausting passage 6 communicating with the light cavity 2.

A conductor wire 7, 7a is electrically extended from the cathode terminal 3 to an exterior of the light tube for electrifying the mercury source while electrical connection, wherein the conductor wire 7, 7a is extended through the conductor enclosure 4 to retain said conductor wire in position within the end portion of the light tube. Accordingly, the conductor wire 7, 7a is coaxially extended with respect to the end portion of the light tube through the conductor enclosure 4 to electrically connect with the cathode terminal 3.

According to the preferred embodiment, the mercury source is liquid mercury contained in the light tube. Alternatively, the mercury source can be an amalgam contained in the light tube or an amalgam integral with the light tube.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An illuminable unit, comprising:
a light tube having a spiral-shaped light body and two end portions downwardly extended therefrom, wherein said light tube further has a light cavity containing a mercury source therein and filling with inert gas, and a phosphor layer coated on an inner wall of said light tube;
a cathode terminal supported at one of said end portions of said light tube;
a conductor enclosure, which has a length approximately equal to a length of each said end portion of said light tube, having an upper head portion sealedly mounted within said respective end portion of said light tube in a concealed manner so as to substantially reduce an overall height of said illuminable unit; and
a conductor wire electrically extended from said cathode terminal to an exterior of said light tube for electrifying said mercury source while electrical connection, wherein said conductor wire is extended through said conductor enclosure so as to retain said conductor wire in position within said end portion of said light tube.

2. The illuminable unit, as recited in claim 1, wherein said conductor enclosure is sealed at a bottom end of said end portion of said light tube to conceal said head portion of said conductor enclosure within said end portion of said light tube, so as to seal said light cavity in an air tight manner.

3. The illuminable unit, as recited in claim 1, wherein said two end potions of said light tube are downwardly extended from said light body in a vertical extending manner, wherein said conductor wire is coaxially extended with respect to said end portion of said light tube through said conductor enclosure to electrically connect with said cathode terminal.

4. The illuminable unit, as recited in claim 2, wherein said two end potions of said light tube are downwardly extended from said light body in a vertical extending manner, wherein said conductor wire is coaxially extended with respect to said end portion of said light tube through said conductor enclosure to electrically connect with said cathode terminal.

5. The illuminable unit, as recited in claim 1, wherein said conductor enclosure has an inner gas exhausting passage communicating with said light cavity.

6. The illuminable unit, as recited in claim 2, wherein said conductor enclosure has an inner gas exhausting passage communicating with said light cavity.

7. The illuminable unit, as recited in claim 4, wherein said conductor enclosure has an inner gas exhausting passage communicating with said light cavity.

8. The illuminable unit, as recited in claim 1, wherein said mercury source is liquid mercury contained in said light tube.

9. The illuminable unit, as recited in claim 4, wherein said mercury source is liquid mercury contained in said light tube.

10. The illuminable unit, as recited in claim 7, wherein said mercury source is liquid mercury contained in said light tube.

11. The illuminable unit, as recited in claim 1, wherein said mercury source is amalgam contained in said light tube.

12. The illuminable unit, as recited in claim 4, wherein said mercury source is amalgam contained in said light tube.

13. The illuminable unit, as recited in claim 7, wherein said mercury source is amalgam contained in said light tube.

14. The illuminable unit, as recited in claim 1, wherein said mercury source is amalgam integral with said light tube.

15. The illuminable unit, as recited in claim 4, wherein said mercury source is amalgam integral with said light tube.

16. The illuminable unit, as recited in claim 7, wherein said mercury source is amalgam integral with said light tube.
